(19) United States
(12) Patent Application Publication
(10) Pub. No.: US 2007/0059414 A1
(43) Pub. Date: Mar. 15, 2007

(54) Method and Process of Using Controlled Gas Environments to Inhibit Microbial Growth

(76) Inventors: John S. Novak, Naperville, IL (US); James T.C. Yuan, Naperville, IL (US); Henry J. Ledon, Versailles (FR)

Correspondence Address: Ms. Linda K. Russell, Air Liquide Intellectual Property Dept., 2700 Post Oak Blvd., Suite 1800, Houston, TX, 77056, US

(21) Appl. No.: 11/460,946

(22) Filed: Jul. 28, 2006

Related U.S. Application Data
(60) Provisional application No. 60/716,467, filed on Sep. 13, 2005.

(51) Int. Cl. A21D 4/00

(52) U.S. Cl. 426/321

(57) ABSTRACT

Methods and apparatus for inhibiting growth and quorum sensing mechanisms in food-borne microorganisms by simultaneously exposing a food product to an antimicrobial gas mixture and a treating agent adapted to inhibit signaling between the microorganisms.

### CROSS-REFERENCE TO RELATED APPLICATIONS

This application claims the benefit under 35 U.S.C. §119(e) to provisional application No. 60/716,467, filed Sep. 13, 2005, the entire contents of which are incorporated herein by reference.

### BACKGROUND

1. Field of the Invention

The invention relates to the improvement of sanitization techniques used during the processing of food products, more specifically to a method of treating food products using an antimicrobial gas mixture and a treating agent comprising a microorganism-signal-inhibiting agent.

2. Description of the Related Art

As microorganisms grow and increase in population density, small signaling molecules are produced to turn on genes in surrounding microorganisms for the production of biofilms, toxins, and other characteristics of the community. Autoinducing chemical signals were first described in the marine symbiont, Vibrio fischeri in the 1970's associated with bioluminescence. Since then, low molecular weight chemical signaling in bacteria as a result of high population density has been termed “quorum sensing”. Quorum sensing is a phenomenon whereby bacteria use small signaling molecules for cell-to-cell communication in response to cell population densities and environmental stresses such as food processing and storage. Virulence characteristics of pathogenic microorganisms such as antibiotic production, biofilm formation, sporulation, and toxin production may be controlled by such signaling molecules and mechanisms.

Different autoinducing compounds for intraspecies signaling have been described for Gram-negative and Gram-positive bacteria. One furanone derivative, designated autoinducer-2 (Al-2), serves a signaling role among and between different Gram-negative and Gram-positive bacteria. Al-2 synthesis is dependent upon the synthetase, LuxS, expressed by the luxS gene. The acceptance of Al-2 as a universal quorum-sensing molecule results from the conserved predominance of luxS homologues in many bacteria even though the presence of Al-2 has not been confirmed in all instances.

Numerous studies to date have reported natural inhibitors of Al-2-directed cellular signaling processes. Many of these quorum sensing analogues or inhibitors, are also aromatic compounds important in the flavor or aroma of fruits and vegetables. 2,5-dimethyl-4-hydroxy-3(2H)-furanone (DMHF), a fungal inhibitor produced naturally by strawberries, is an important component of the attractive aroma of certain fruit and a volatile inhibitor of quorum sensing. A furanone produced by the sea alga, Delisea pulchra, inhibited virulence characteristics, such as biofilm formation and swarming of E. coli. Another naturally occurring furanone, ascorbic acid (vitamin C), has antimicrobial properties similar to other known natural inhibitors of quorum sensing.

Over 30% of the 5,000 food-borne deaths in the United States each year are caused by three pathogens: Salmonella, Listeria, and Toxoplasma. Approximately 2 to 4 million cases of Salmonellosis occur annually in the U.S. While only 2,000 cases of Listeriosis are reported, over 20% of these result in death. Similarly, over 60,000 cases of E. coli O157:H7 food-borne disease are estimated annually, with 3% of these resulting in hospitalizations, and 0.1% in deaths. Many of these diseases are preventable and the incidence of these and similar food-borne pathogens could be reduced by altering conditions necessary to trigger gene expression related to food-borne illness.

Modified atmosphere packaging (MAP) has proven to be ineffective in eliminating potential pathogens in packaged food products. The most common gases used to modify a food product's atmospheric environment with the intention of inhibiting microbial growth while increasing product shelf-life include oxygen (O₂), carbon dioxide (CO₂), and nitrogen (N₂). Reducing O₂ concentrations from 21% to 1-5% reduce respiration rates of fruits and vegetables, thereby slowing ripening and maturation. Levels of O₂ below 1% however, are detrimental to produce flavors and increase hazards from anaerobic pathogens. Oxygen levels above 70% have been shown to be effective in inhibiting the growth of certain microorganisms, but also stimulate the growth of the food-borne pathogens, E. coli and L. monocytogenes. Carbon dioxide is also known to affect microbial growth. While CO₂ has been reported to have inhibitory effects on microorganisms at elevated concentrations above 5%, spoilage lactic acid bacteria can then thrive and reduce the shelf-life of the food products. 10-20% CO₂ has been shown to inhibit Salmonella enteriditis, but not Salmonella typhimurium. Another pathogen of concern in ready-to-eat deli meat products, L. monocytogenes, is capable of withstanding levels of CO₂ up to 50%. Unrestricted over-use of CO₂ can create undesirable color changes in meats. Also, if CO₂ is added in very high concentrations, product flavors may be compromised and samples may become anaerobic permitting the growth of Clostridium botulinum, responsible for a very potent neurotoxin.

If quorum sensing mechanisms can be inhibited in food-borne microorganisms, the microorganisms may be less resistant to antimicrobial treatments and less likely to cause illness or disease. Therefore, a method is needed to inhibit growth and quorum sensing mechanisms in food-borne microorganisms that might otherwise express virulent characteristics.

### SUMMARY

Aspects of the invention generally provide methods and treating agents for inhibiting growth and quorum sensing mechanisms in food-borne microorganisms. In one embodiment, the invention provides a method for treating a food product comprising exposing the food product to a microorganism-signal-inhibiting agent and a gas mixture simultaneously.

In another embodiment, the invention provides a method of packaging a food product comprising placing a food product in a container possessing a treating agent, wherein the treating agent comprises a microorganism-signal-inhibiting agent, flushing the container with a gas mixture after placing the food product in the container, and sealing the container after flushing the container with the gas mixture.

In another embodiment, the invention provides A method of packaging a food product comprising placing a food product in a container possessing a treating agent, wherein the treating agent comprises microorganism-signal-inhibiting agent, creating a vacuum in the container after placing the food product in the container, flushing the container with a gas mixture after placing the food product in the container, and sealing the container after flushing the container with the gas mixture.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 exhibits the main processing steps entailed by the embodiments of the invention.

FIG. 2 shows a treating agent according to one embodiment of the invention.

FIG. 3 shows a method of treating a food product according to one embodiment of the invention.

FIG. 4 shows a method of treating a food product according to another embodiment of the invention.

FIG. 5 shows a method of packaging a food product according to one embodiment of the invention.

### DESCRIPTION OF PREFERRED EMBODIMENTS

The words and phrases used herein should be given their ordinary and customary meaning in the art by one skilled in the art unless otherwise further defined.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Quorum sensing is a phenomenon whereby microorganisms use small signaling molecules for cell-to-cell communication in response to cell population densities and environmental stresses. As microorganisms grow and increase in population density, small signaling molecules are produced to turn on genes in surrounding microorganisms for the production of biofilms, toxins, and other characteristics of the community. If these signaling mechanisms can be turned off or inhibited during food processing steps, the microorganisms will be less resistant to antimicrobial treatments and less likely to cause illness or disease. Aspects of the invention generally provide methods and treating agents for inhibiting growth and quorum sensing mechanisms in food-borne microorganisms. More specifically, embodiments of the invention provide a means of treating food products by simultaneously exposing the food product to an antimicrobial gas mixture and a microorganism-signal-inhibiting treating agent. In various embodiments, the treating agent may be a furanone, a furanone analogue and/or a furanone derivative. However, while embodiments described below are described with reference to furanones, it is contemplated that any signal inhibiting treating agent may be used instead or in addition. Thus, the microorganism-signal-inhibiting treating agent refers to any molecule, natural or synthetic, known to inhibit signaling mechanisms in microorganisms.

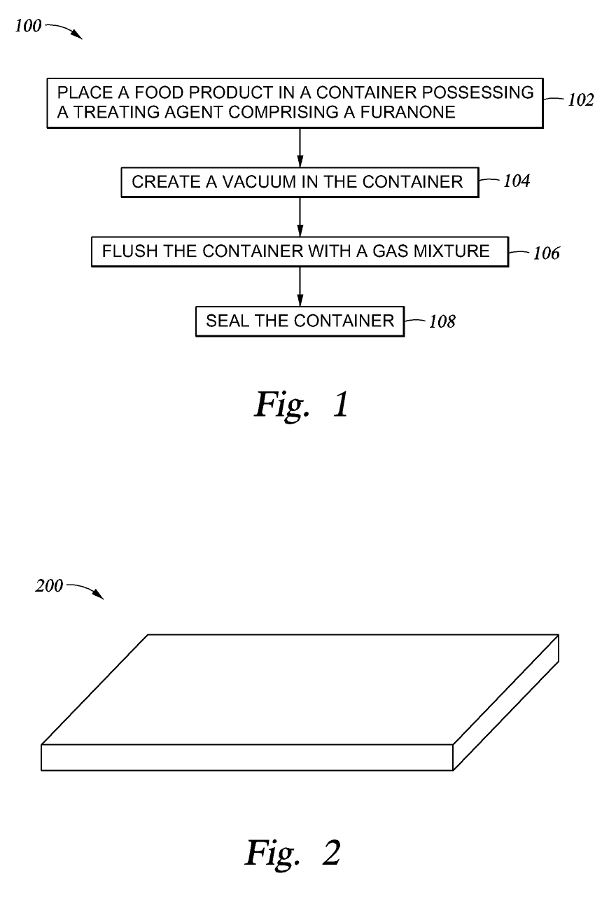

FIG. 1 is a flow diagram of a process 100, according to one embodiment of the present invention. The process 100 includes a processing step 102 involving placing a food product in a container possessing a treating agent, wherein the treating agent is a microorganism-signal-inhibiting agent adapted to interfere with signaling between bacterial microorganisms on the food product and/or the container. In one embodiment, the treating agent is a furanone. Processing step 104 is an optional step involving the creation of a vacuum in the container after placing the food product in the container. Processing step 106 involves flushing the container with a gas mixture after placing the food product in the container. Finally, processing step 108 involves sealing the container after flushing the container with the gas mixture.

The processing steps 102-108 according to the embodiments of the invention are described below. The embodiments described herein are provided to illustrate the invention and the particular embodiments shown should not be used to limit the scope of the invention.

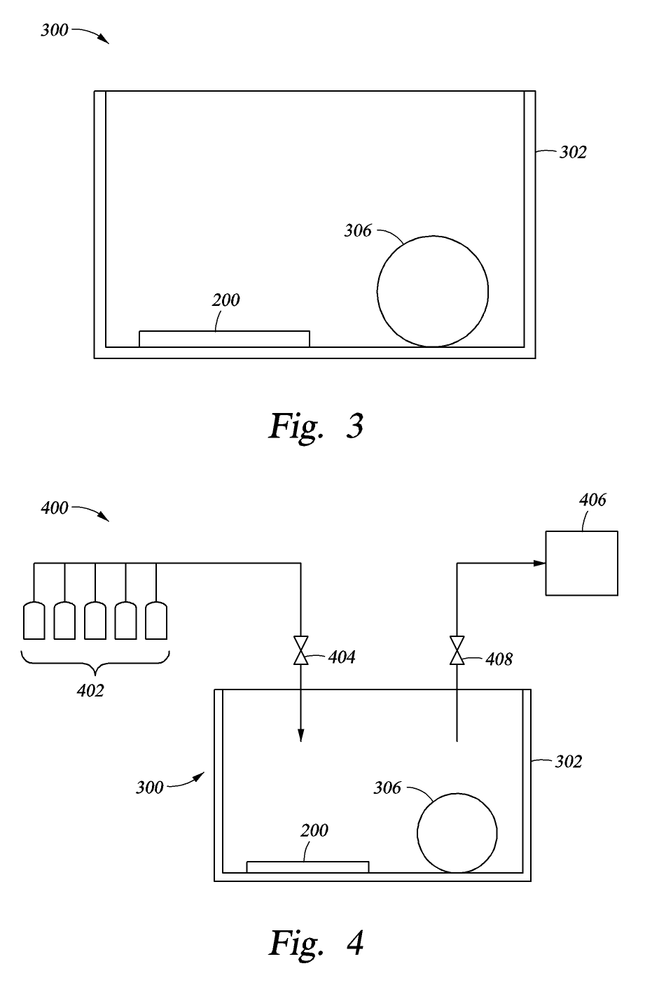

FIG. 2 shows a treating agent 200 according to one embodiment of the present invention. In this embodiment, the treating agent is an adsorbent material capable of retaining volatile furanones in liquid form. In embodiments of the invention, the adsorbent material can be cellulose or cotton. In one embodiment, the absorbent material may be autoclaved provided the polymer fibers can withstand the autoclaving conditions, e.g., 121° C. and 15 psi for at least 20 minutes. After the absorbent material is sterilized by autoclaving or drying, the adsorbent material is dipped in liquid solutions containing known natural furanones, such as DMHF and ascorbic acid. Preferred embodiments involve pre-soaking the adsorbent material in solutions containing about 1 M to 100 M natural furanone. The solution of furanone can be sterilized by filtration. In one embodiment, the adsorbent material may then be blotted on a sanitized surface. The adsorbent material is then placed in a desired container. Embodiments of the invention can involve the use of any type of container used during food processing steps, including a food packaging container, food storage container, or food transport container. Upon placing the treating agent in the interior of a container, processing step 102 describes placing a food product in the container possessing the treating agent. FIG. 3 exhibits a container 300 comprising a packaging film 302, treating agent 200 and a food product 306, according to one embodiment. In various embodiments, the food product can include fruits, vegetables, meats, or other processed foods.

FIG. 4 exhibits one embodiment of the invention used to package a food product 306. A treating agent 200 and food product 306 are placed in an open container 300. An instrument 406 is used to generate a vacuum in the container 300 by means of a valve 408. In one embodiment, a Packaging Machine (available from Multivac, Inc., Kansas City, Mo.) is used to generate a vacuum in the container. Immediately after the vacuum has been created in the container, one or more gas sources, represented by group 402, can provide a gas mixture by means of a valve 404 to a container 300. In one embodiment, a gas mixer (available from PBI Dansensor, Glen Rock, N.J.) can be used to mix gases, or in another embodiment, a pre-mixed gas mixture can be ordered. A food package head space analyzer (available from Servomex, Inc., Sugar Land, Tex.) or gas chromatograph can be used to confirm gas mixtures in the packages. The gas mixture can comprise gases selected from the group consisting of carbon dioxide (CO₂), nitrogen (N₂), hydrogen (H₂), nitrous oxide (N₂O), argon (Ar), oxygen (O₂), helium (He), krypton (Kr), and combinations thereof. The gas mixture can be selected on the basis of an observed enhancement of an effect produced by the treating agent (e.g., the furanone), the effect being inhibiting intercellular signaling of food-borne microorganisms. The one or more inert gases may be injected into the vessel in processing step 106 to help tune and maintain the partial pressure and alter properties such as the concentration of the injected gas mixture. The one or more inert gases can be pre-mixed with CO₂ a separate vessel and injected together, or injected separately.

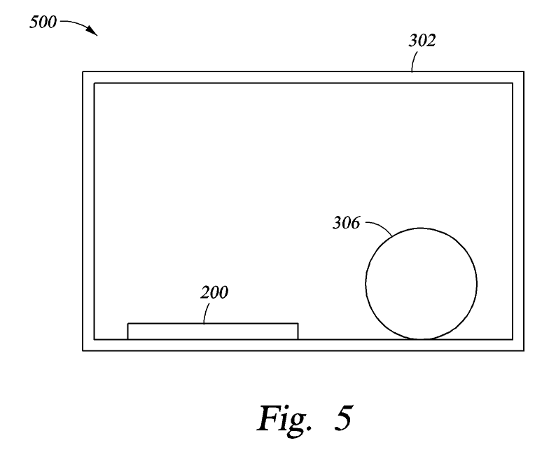

FIG. 5 shows a food package 500 containing a treating agent 200 and food product 306 according to one embodiment of the invention. After the previously described gas mixture has been added to the container, the container is immediately sealed at atmospheric pressure using a packaging film 302 in a packaging machine (available from Multivac, Inc., Kansas City, Mo.). A packaging film 302 with low or high oxygen transmission rate could be used, provided that the volatile aromatic furanone provided by the treating agent does not escape the package through the film. The food product 306 can now be exposed simultaneously to a furanone from the treating agent 200 and a gas mixture in the container space 504.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for treating a food product, comprising exposing the food product to a furanone and a gas mixture simultaneously.

2. The method of claim 1, wherein the furanone is 2,5-dimethyl-4-hydroxy-3(2H)-furanone (DMHF).

3. The method of claim 1, wherein the furanone is ascorbic acid.

4. The method of claim 1, wherein the gas mixture comprises gases selected from the group consisting of carbon dioxide, nitrogen, hydrogen, nitrous oxide, argon, oxygen, helium, krypton, and combinations thereof.

5. The method of claim 1, wherein the gas mixture is selected on the basis of an observed enhancement of an effect produced by the furanone, the effect being inhibiting intercellular signaling of food-borne microorganisms.

6. A method for packaging a food product, comprising:
a) placing a food product in a container possessing a treating agent, wherein the treating agent inhibits signaling between food-borne microorganisms;
b) flushing the container with a gas mixture after placing the food product in the container; and
c) sealing the container after flushing the container with the gas mixture.

7. The method of claim 6, wherein the treating agent is disposed on an adsorbent material, the absorbent article having been soaked in a liquid containing the treating agent.

8. The method of claim 7, wherein the adsorbent material comprises cotton.

9. The method of claim 7, wherein the adsorbent material comprises cellulose.

10. The method of claim 7, wherein the adsorbent material is presoaked in a solution containing between about 1 M and 100 M DMHF.

11. The method of claim 7, wherein the adsorbent material is presoaked in a solution containing between about 1 M and 100 M ascorbic acid.

12. The method of claim 6, wherein the container is selected from a group consisting of a food package, a food storage container, and a food transport container.

13. The method of claim 6, wherein the treating agent comprises 2,5-dimethyl-4-hydroxy-3(2H)-furanone (DMHF).

14. The method of claim 6, wherein the treating agent comprises ascorbic acid.

15. The method of claim 6, wherein the gas mixture comprises gases selected from the group consisting of carbon dioxide, nitrogen, hydrogen, nitrous oxide, argon, oxygen, helium, krypton, and combinations thereof.

16. The method of claim 6, wherein the container is sealed at atmospheric pressure.

17. A method for packaging a food product, comprising:
a) placing a food product in a container having a treating agent therein, wherein the treating agent is selected on the basis of an ability to interfere with intercellular signaling between food-borne microorganisms;
b) creating a vacuum in the container after placing the food product in the container;
c) flushing the container with a gas mixture after placing the food product in the container; and
d) sealing the container after flushing the container with the gas mixture.

18. The method of claim 17, wherein the treating agent is disposed on an adsorbent material.

19. The method of claim 18, wherein the adsorbent material comprises cotton.

20. The method of claim 18, wherein the adsorbent material comprises cellulose.

21. The method of claim 18, wherein the adsorbent material is presoaked in a solution containing between about 1 M and 100 M DMHF, the DMHF being the treating agent.

22. The method of claim 18, wherein the adsorbent material is presoaked in a solution containing between about 1 M and 100 M ascorbic acid, the ascorbic acid being the treating agent.

23. The method of claim 17, wherein the container is selected from a group consisting of a food package, a food storage container, and a food transport container.

24. The method of claim 17, wherein the treating agent comprises 2,5-dimethyl-4-hydroxy-3(2H)-furanone (DMHF).

25. The method of claim 17, wherein the being the treating agent comprises ascorbic acid.

26. The method of claim 17, wherein the gas mixture comprises gases selected from the group consisting of carbon dioxide, nitrogen, hydrogen, nitrous oxide, argon, oxygen, helium, krypton, and combinations thereof.

27. The method of claim 17, wherein the container is sealed at atmospheric pressure.
